(19) United States
(12) Patent Application Publication
(10) Pub. No.: US 2021/0256422 A1
(43) Pub. Date: Aug. 19, 2021

(54) Predicting Machine-Learned Model Performance from the Parameter Values of the Model

(71) Applicant: Google LLC, Mountain View, CA (US)

(72) Inventors: Thomas Unterthiner, Berlin (DE); Daniel Martin Keysers, Stallikon (CH); Sylvain Gelly, Zurich (CH); Olivier Jean Andre Bousquet, Zurich (CH); Ilya Tolstikhin, Zurich (CH)

(21) Appl. No.: 17/177,362

(22) Filed: Feb. 17, 2021

Related U.S. Application Data
(60) Provisional application No. 62/978,706, filed on Feb. 19, 2020.

(51) Int. Cl. G06N 20/00; G06K 9/62

(52) U.S. Cl. CPC G06N 20/00; G06K 9/6289; G06K 9/6265

(57) ABSTRACT

Provided are systems and methods for predicting machine learning model performance from the model parameter values, including for use in making improved decisions with regard to early stopping of training procedures. As one example, the present disclosure discusses the prediction of the accuracy (e.g., relative to a defined task and testing dataset such as a computer vision task) of trained neural networks (e.g., convolutional neural networks (CNNs)), using only the parameter values (e.g., the values of the network's weights) as inputs. As such, one example aspect of the present disclosure is directed to computing systems that include and use a machine-learned performance prediction model that has been trained to predict performance values of machine-learned models based on their parameter values (e.g., weight values and/or hyperparameter values).

### RELATED APPLICATIONS

This application claims priority to and the benefit of U.S. Provisional Patent App. No. 62/978,706, filed Feb. 19, 2020. Each application identified above is incorporated herein by reference in its entirety.

### FIELD

The present disclosure relates generally to predicting machine learning model performance from the model parameter values. More particularly, the present disclosure relates to the prediction of the accuracy of a neural network given only its weights with a goal of better understanding network training and performance, including making improved decisions with regard to early stopping of training procedures.

### BACKGROUND

Various machine-learned models such as, for example, deep neural networks (DNNs) are assessed state of the art methods for many problems today. Yet, a deeper understanding of the mechanisms underlying these successes is still lacking. The deep learning phenomena, i.e. various surprising and insightful empirical findings surrounding the efforts to understand DNN training and generalization have recently gained a lot of attention of researchers and practitioners. Research in this direction is actively growing, yet many such phenomena remain to be discovered.

As an example, there are only few works that consider the problem of predicting model performance. For example, one line of research investigates how to predict the generalization gap, i.e. the difference between training and test set performance, of a neural network based on the hidden activations of training set examples. One such approach trains large CNN/ResNet architectures on CIFAR datasets and approximates the minimal distances to the class boundary for each data point in each hidden layer. This technique uses this margin distribution to train a linear regressor that predicts generalization gaps.

Another example approach expands upon this direction by training a large number of small fully-connected networks on different variations of a generated spiral dataset. This technique replaces the linear predictor with a recurrent neural network to handle varying neural network depth and shows that predictions transfer between small fully-connected architectures and varying synthetic datasets.

Both of these approaches, however, heavily rely on the margins in the intermediate layers of the networks. These margins cannot be computed analytically and require a computationally expensive approximation procedure, which is not guaranteed to be accurate. Margin approximation also involves an inference pass over the training set.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computing system to predict a performance value of a machine-learned model based on its parameter values, the computer system including: one or more processors; and one or more non-transitory computer-readable media. The one or more non-transitory computer-readable media collectively store a machine-learned performance prediction model that has been trained to predict performance values of machine-learned models based on their parameter values. The one or more non-transitory computer-readable media collectively store instructions that, when executed by the one or more processors, cause the computing system to perform operations. The operations include obtaining data descriptive of a plurality of parameter values associated with a plurality of parameters of an assessed machine-learned model. The operations also include inputting the data descriptive of the plurality of parameter values associated with the plurality of parameters of the assessed machine-learned model into the machine-learned performance prediction model. The operations also include generating, using the machine-learned performance prediction model, a predicted performance value of the assessed machine-learned model based on the data descriptive of the plurality of parameter values associated with the plurality of parameters of the assessed machine-learned model. The operations also include providing the predicted performance value of the assessed machine-learned model as an output. Other embodiments of this aspect include corresponding computer systems, apparatus, and computer programs recorded on one or more computer storage devices, each configured to perform the operations.

Implementations may include one or more of the following features. The computing system of claim 1, where: said operations of obtaining, inputting, generating, and providing are performed during training of the assessed machine-learned model. The operations may further include determining, by the computing system, whether to perform early stopping of the training of the assessed machine-learned model based at least in part on the predicted performance value of the assessed machine-learned model. The computing system of claim 1, where: the assessed machine-learned model includes a neural network. The computing system where: the plurality of parameter values include a plurality of weight values respectively associated with the neural network. The computing system of claim 1, where the plurality of parameter values associated with the plurality of parameters of the assessed machine-learned model include a plurality of hyperparameter values associated with the plurality of hyperparameters of the assessed machine-learned model. The computing system of claim 1, where the performance value includes a test accuracy value relative to a defined testing dataset. The computing system where the test accuracy value includes a future test accuracy value that assumes training of the assessed machine-learned model is completed to convergence. The computing system of claim 1, where the data descriptive of the plurality of parameter values associated with the plurality of parameters of the assessed machine-learned model includes: a set of flattened parameter values of a single layer of the assessed machine-learned model. The computing system of claim 1, where the data descriptive of the plurality of parameter values associated with the plurality of parameters of the assessed machine-learned model includes: one or more statistics descriptive of the plurality of parameter values associated with the plurality of parameters of the assessed machine-learned model. The computing system where the one or more statistics include one or more of: a mean, a variance, and/or one or more percentile values for all of the plurality of parameter values associated with the plurality of parameters of the assessed machine-learned model. The computing system where the one or more statistics include one or more of: a mean, a variance, and/or one or more percentile values of the plurality of parameter values associated with the plurality of parameters, computed independently for one or more of a plurality of layers of the assessed machine-learned model. The computing system of claim 1, where the data descriptive of the plurality of parameter values associated with the plurality of parameters of the assessed machine-learned model includes: one or more norms of the plurality of parameter values associated with the plurality of parameters, computed independently for one or more of a plurality of layers of the assessed machine-learned model. The computing system, where the machine-learned performance prediction model includes a gradient boosting machine with regression trees. The computing system, where the machine-learned performance prediction model includes a logit-linear model or a fully-connected neural network. Implementations of the described techniques may include hardware, a method or process, or computer software on a computer-accessible medium.

Another general aspect includes a computer-implemented method for performing early stopping of machine-learned model training, the method including: obtaining, by a computing system including one or more computing devices, a training dataset and an assessed machine-learned model to be trained on the training dataset; training, by the computing system, the assessed machine-learned model on the training dataset for a plurality of training iterations, where one or more of the plurality of training iterations includes. The computer-implemented method also includes obtaining, by the computing system, data descriptive of a plurality of current parameter values associated with a plurality of parameters of a current instance of the assessed machine-learned model. The computer-implemented method also includes inputting, by the computing system, the data descriptive of the plurality of current parameter values into a machine-learned performance prediction model. The computer-implemented method also includes generating, by the computing system and using the machine-learned performance prediction model, a predicted performance value of the assessed machine-learned model based on the data descriptive of the plurality of current parameter values. The computer-implemented method also includes determining, by the computing system, whether to perform early stopping of the training of the assessed machine-learned model based at least in part on the predicted performance value of the assessed machine-learned model. Other embodiments of this aspect include corresponding computer systems, apparatus, and computer programs recorded on one or more computer storage devices, each configured to perform the actions of the methods.

Implementations may include one or more of the following features. The computer-implemented method further including, at at least one training iteration of the plurality of training iterations: performing early stopping of the training of the assessed machine-learned model based at least in part on the predicted performance value of the assessed machine-learned model. The computer-implemented method where determining whether to perform early stopping of the training of the assessed machine-learned model based at least in part on the predicted performance value of the assessed machine-learned model includes: comparing the predicted performance value of the assessed machine-learned model to a threshold performance value. The computer-implemented method may also include determining that early stopping should be performed when the predicted performance value of the assessed machine-learned model is less than the threshold performance value. The computer-implemented method, where determining whether to perform early stopping of the training of the assessed machine-learned model based at least in part on the predicted performance value of the assessed machine-learned model includes: comparing the predicted performance value of the assessed machine-learned model to an alternative performance value associated with an alternative machine-learned model. The computer-implemented method may also include determining that early stopping should be performed when the predicted performance value of the assessed machine-learned model is less than the alternative performance value associated with the alternative machine-learned model. The computer-implemented method, where determining whether to perform early stopping of the training of the assessed machine-learned model based at least in part on the predicted performance value of the assessed machine-learned model includes: generating a performance versus training round plot based on the predicted performance value of the assessed machine-learned model. The computer-implemented method may also include determining whether to perform early stopping of the training of the assessed machine-learned model based at least in part on the performance versus training round plot. The computer-implemented method, where: the machine-learned performance prediction model includes a recurrent neural network. The computer-implemented method may also include inputting, by the computing system, the data descriptive of the plurality of current parameter values into the machine-learned performance prediction model includes inputting to machine-learned performance prediction model a sequence of sets of parameter values of sequential instances of the assessed machine-learned model obtained at a number of training checkpoints. Implementations of the described techniques may include hardware, a method or process, or computer software on a computer-accessible medium.

Another general aspect includes one or more non-transitory computer-readable media that collectively store instructions that, when executed by one or more processors, cause the one or more processors to perform operations, the operations including: generating a sample model performance dataset by labelling a plurality of parameter value datasets respectively associated with a plurality of sample machine-learned models with a corresponding performance value exhibited by the corresponding sample machine-learned model. The operations also include using the sample model performance dataset to train a machine-learned performance prediction model to predict the performance values of the sample machine-learned models based on the corresponding parameter value dataset. Other embodiments of this aspect include corresponding computer systems, apparatus, and computer programs recorded on one or more computer storage devices, each configured to perform the actions of the methods.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow chart diagram of an example method to generate and use a sample model performance dataset to learn a machine-learned performance prediction model according to example embodiments of the present disclosure.

FIG. 2 depicts a flow chart diagram of an example method to use a machine-learned performance prediction model to perform early stopping of assessed model training according to example embodiments of the present disclosure.

FIGS. 3A-C depicts block diagrams of example computing systems according to example embodiments of the present disclosure.

Reference numerals that are repeated across plural figures are intended to identify the same features in various implementations.

### DETAILED DESCRIPTION

### Overview

Generally, the present disclosure is directed to systems and methods for predicting machine learning model performance from the model parameter values, including for use in making improved decisions with regard to early stopping of training procedures. As such, one example aspect of the present disclosure is directed to computing systems that include and use a machine-learned performance prediction model that has been trained to predict performance values of machine-learned models based on their parameter values (e.g., weight values and/or hyperparameter values). As one example, the present disclosure discusses the prediction of the accuracy (e.g., relative to a defined task such as a computer vision task performed on a testing dataset) of trained neural networks (e.g., convolutional neural networks (CNNs)), using only the parameter values (e.g., the values of the network's weights) as inputs.

One example practical application of the ability to predict model performance is performance of early stopping of (likely) unsuccessful training runs. For example, the machine-learned performance prediction model described herein can be used to predict the performance of an assessed model during training of the assessed machine-learned model. The training computing system can determine whether to perform early stopping of the training of the assessed machine-learned model based at least in part on the predicted performance value of the assessed machine-learned model that was predicted by the machine-learned performance prediction model. For example, the predicted performance value for the assessed machine-learned model can be compared to one or more threshold values and/or to alternative performance values associated with alternative models to determine whether to perform early stopping of the training of the assessed model.

The systems and methods described herein are also transferrable across model parameterizations, size, related tasks, and/or related datasets. As one example, certain portions of the present disclosure discuss CNNs trained on one dataset. Then it is shown that the findings transfer to the CNNs trained on other datasets. In addition, the present disclosure demonstrates that the predictor trained on a collection of very small underparametrized CNNs is capable of ranking the big overparametrized ResNet models according to train/test accuracy fairly well using only their weights.

Thus, one aspect of the present disclosure is directed to a new formal setting that captures the approach and relates to previous works. Another aspect of the present disclosure provides a new, large dataset with strong baselines and discuss extensive empirical results. The data is of a new modality, mapping trained weights of machine-leaned models (e.g., neural networks) to their performance (e.g., accuracy).

Example experiments on example implementations of the systems and methods described herein show that it is possible to predict the accuracy using trained weights alone. Furthermore, only a few statistics of the weights are sufficient for high accuracy in prediction. Additional example experiments on transfer of prediction across architectures and datasets show that it is also possible to rank neural network models trained on an unknown dataset just by observing the trained weights, without ever having access to the dataset itself.

The systems and methods of the present disclosure provide a number of technical effects and benefits. As one example technical effect and benefit, the amount of computing resources needed to evaluate a performance metric (e.g., accuracy) of an assessed machine-learned model can be greatly reduced. In particular, in existing techniques, to evaluate the performance of an assessed machine-learned model, many instances of testing input examples must be input into the assessed machine-learned model to receive predictions from the assessed machine-learned model. These predictions are then compared to corresponding instances of testing output examples to determine whether the assessed machine-learned model has correctly predicted the example. Thus, testing the assessed machine-learned model requires many instances of performing inference with the assessed machine-learned model to evaluate its performance. In contrast, the present disclosure requires only a single inference from a machine-learned performance prediction model to predict the performance of the assessed machine-learned model. Thus, a single inference can be performed rather than many, thereby greatly reducing the use of computational resources such as processor, memory, and/or network bandwidth usage.

In addition, certain existing techniques for predicting model performance predict the generalization gap, i.e. the difference between training and test set performance, of a neural network based on the hidden activations of training set examples. These approaches, however, heavily rely on the margins in the intermediate layers of the networks. These margins cannot be computed analytically and require a computationally expensive approximation procedure, which is not guaranteed to be accurate. Margin approximation also involves an inference pass over the training set. In contrast, the present disclosure requires only a single inference from a machine-learned performance prediction model to predict the performance of an assessed machine-learned model. Therefore, neither computationally expensive approximation procedure nor an inference pass of the assessed model over the training set is required.

Another example technical effect and benefit is achieved when the performance predictions described herein are leveraged to perform intelligent early stopping of model training. In particular, by successfully performing early stopping of model training iterations that are unlikely to result in a high-performing model, unnecessary or fruitless training computations can be reduced or eliminated. This results in saving computing resources such as processor, memory, and/or network bandwidth usage. Viewed differently, by successfully performing early stopping of model training iterations that are unlikely to result in a high-performing model, a high-performing result can be achieved faster and with fewer resource expenditure. As such, the systems and methods described herein can enable faster model training.

Another example technical effect and benefit relates to increased privacy. In particular, since aspects of the present disclosure enable the prediction of model performance based only on its parameter values, estimates of model performance can be achieved without needing to have access to any underlying dataset, including the testing and/or training dataset against which the model's performance is being predicted. Thus, a model's performance can be evaluated (e.g., for selection and deployment to a user) without having any access to the underlying data (e.g., which may be private to the user), thereby enhancing data privacy.

In some implementations, the systems and methods described herein can be included and/or implemented within or by a cloud-based model training and/or generation platform or web service. For example, a user can supply a model and/or dataset and the cloud platform can automatically generate an optimized model for deployment by or for the user. For example, the techniques described herein can be used to reduce the computational burden associated with automatically searching for the best model parameters to meet the user's desired model specification.

With reference now to the Figures, example embodiments of the present disclosure will be discussed in further detail.

### Discussion of Example Formal Setting

Consider a fixed unknown data-generating distribution [symbol] (X,Y) defined over [symbol] where [symbol] and [symbol] are input and output domains, respectively. In example contexts for this disclosure, [symbol] can be the space of input data (e.g., text, images, audio signals, and/or any other input domains) and [symbol] can be a set of class labels or other data modalities that characterize the input data. A training set of input-output pairs S_{N}:={(Xᵢ,Yᵢ)}ᵢ₌₁^{N} can be sampled i.i.d. from [symbol] .

The present disclosure proposes generating a number of machine-learned models (e.g., CNNs) on S_{N} using hyperparameters λ to get a particular weight vector W= [symbol] (S_{N},λ) for each model, where [symbol] denotes the learning procedure and W may be assessed a flattened vector containing all the weights. These models can be referred to as “sample models.”

The hyperparameters λ can include architecture-specific details (e.g. number of layers and activation function), optimizer-specific details (e.g. learning rate and initialization variance), and/or other parameters (e.g. weight regularization and fraction of the training set to use). Notice that the training method [symbol] may have internal sources of stochasticity, including order of examples in mini-batches or weight initialization. Also note that depending on λ, the weight vector W may be of a variable dimension (e.g. for varying number of layers).

The function realized by the sample model (e.g., CNN) with weights W can be denoted using h(⋅;W): [symbol] . This function has the train accuracy

$$\frac{1}{N} {\sum }_{i = 1}^{N} 1 \{ h ( {X}_{i} ; W ) = {Y}_{i} \}$$

and the expected accuracy [symbol] [1{h(X;W)=Y}] denoted with [symbol] (W,S_{N}) and [symbol] (W), respectively.

One example goal achieved in this disclosure is to predict the performance (e.g., expected accuracy) of another model (e.g., which may be referred to as an “assessed model”) by looking at its parameter values (e.g., its weights W). Importantly, since the data distribution [symbol] (X,Y) is fixed, the mapping W [symbol] (W) that is learned exists and is defined uniquely. Unfortunately, it is generally unknown, as well as [symbol] , and to this end the present disclosure proposes to estimate it with a predictor \hat{F}: [symbol] →[0,1], which can be referred to or embodied as a machine-learned performance prediction model.

Although certain portions the present disclosure focuses on accuracy as the performance metric of interest, other measures of performance can be predicted as well, including compressibility, area under curve, mean squared error, cross entropy loss, number of mistakes made over a test set, robustness (e.g., against adversarial attacks or in an out of distribution setting), and/or various other measures of performance. These alternative performance measures can be used instead of accuracy by instead changing to mapping to be predicted/estimated from W [symbol] (W) to W [symbol] whichever performance metric is desired. Stated differently, any description of the techniques contained herein which is specific to accuracy can be generalized to any other performance metric by simply replacing accuracy as the metric to be learned/predicted by the predictor \hat{F}.

To build a predictor/estimator \hat{F}, one can specify how to measure its quality. In other words, one can define how to measure how similar the mappings [symbol] (⋅) and \hat{F}(⋅), both defined on [symbol] , are. Since aspects of this work are related to studying model training, one example means of comparison is to not compare the two on the entire space [symbol] but rather focus on the subset consisting of weights that can be actually obtained as a result of training. For example, to facilitate this comparison, a set of hyperparameter configurations λ₁, . . . , λ_{K} can be generated and then K different models (e.g., CNNs) Wₖ= [symbol] (S_{N};λₖ) can be trained on the training set S_{N}. As indicated above, these models Wₖ can be referred to as “sample models.”

In some implementations, the exact values of [symbol] (Wₖ) are generally not computed, but are instead well estimated using the test accuracy Tₖ: [symbol] (Wₖ,S_{M},) measured on the separate test set of i.i.d. input-output pairs S′_{M}={(X′ⱼ,Y′ⱼ)}ⱼ₌₁^{M} sampled from [symbol] independently of S_{N}. Finally, the estimator \hat{F} can be trained by by minimizing its Mean Squared Error (MSE) on the sample model collection [symbol] :={(Wₖ,Tₖ)}ₖ₌₁^{K}.

Why use only weights? The framework proposed above already makes use of the dataset S_{N} by training sample models (e.g., CNNs) W₁, . . . , W_{K} on it. This means that the estimator \hat{F} and, as a consequence, its predictions, implicitly depend on S_{N}. A natural idea would be to make the dependence on S_{N} more explicit: e.g., by holding out some part S⊆S_{N} and returning [symbol] (W,S) as a prediction for the accuracy of the model W. Based on decades of theoretical and practical ML experience, this approach will likely provide a very strong baseline for the task of predicting the accuracy. So why consider predictors \hat{F} that only look at weights and not utilize S_{N} explicitly?

One reason is that predicting the accuracy is not the only objective which can be achieved by the proposed approach. Ultimately, additional insights can be gained about DNN training and generalization by understanding the structure of network weights, which are some of the most prominent characteristics of the DNN. Other advantages of not choosing another set S⊆S_{N} to compute [symbol] (W,S) can be of a more practical nature: supporting prediction with less computational effort than an inference pass over S requires. Likewise, the present disclosure enables predicting the performance of a model even when access to the underlying dataset S_{N} is not available.

Example Predictions from Hyperparameters

Another important and related question is the extent to which the test accuracy of W= [symbol] (S_{N},λ) can be predicted from the hyperparameters λ that were used to train it. Once the training set S_{N} and the random seed which determines the learning procedure's internal source of stochasticity are fixed, there exists a unique deterministic mapping λ [symbol] (W) which can also be estimated using the same scheme as described above. While the Bayes error of both using λ or the resulting weights W for predicting the accuracy is 0, in practice the two problems may have different sample complexities.

If the training set S_{N} and/or the random seed are not fixed but instead generated each time the sample model is trained, the mappings λ [symbol] (S_{N},λ) and, as a consequence, λ [symbol] [symbol] (W) both become stochastic. In this case the estimation is possible only up to the noise introduced by the variance of S_{N} and/or different choices of the seed.

Example Domain Shift

Another aspect of the present disclosure examines whether the learned estimator \hat{F} generalizes to yet unseen data distributions [symbol] or hyperparameter configurations λ. In other words, if an estimator \hat{F} were trained on on sample models (e.g., CNNs) which were themselves trained on a first training dataset (e.g., CIFAR10), how accurately would \hat{F} predict the test accuracy of another model trained on second, different training dataset (e.g., SVHN)? This setting can be referred to as domain shift. A priori, even if the original problem is well solved on CIFAR10, there are no guarantees that the estimator would perform well for SVHN. The same applies to a change in the architecture. However, example experiments contained in U.S. Provisional Patent App. No. 62/978,706 indicate that indeed a learned estimator \hat{F} trained using sample models trained on a first training dataset is able to provide predictions of model performance for assessed models on a second, different dataset which are useful for, at a minimum, relative ranking among a plurality of assessed models (e.g., which may be alternative candidates for deployment).

### Example Techniques for Generating a Sample Model Training Dataset and Training a Machine-Learned Performance Prediction Model

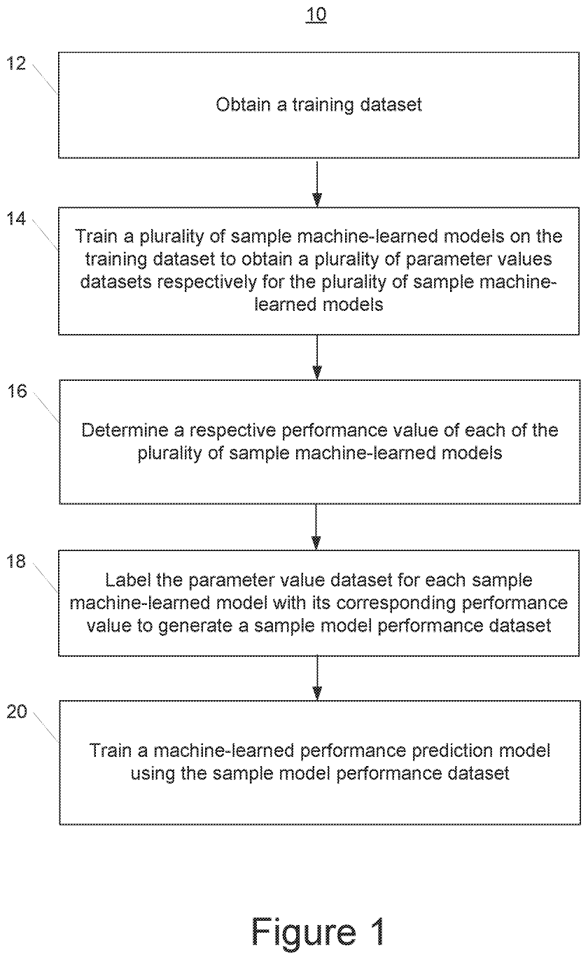

FIG. 1 depicts a flow chart diagram of an example method 10 to train a machine-learned performance prediction model according to example embodiments of the present disclosure. Although FIG. 1 depicts steps performed in a particular order for purposes of illustration and discussion, the methods of the present disclosure are not limited to the particularly illustrated order or arrangement. The various steps of the method 10 can be omitted, rearranged, combined, and/or adapted in various ways without deviating from the scope of the present disclosure.

At 12, a computing system can obtain a training dataset. For example, the training dataset can have a number of example inputs that are labelled with corresponding example outputs. The inputs can be of any different data domain including imagery, text, audio, numerical data, other domains of data and/or combinations thereof. The outputs can be ground truth class labels, regression labels, or other forms of outputs.

At 14, the computing system can initialize and train a plurality of sample machine-learned models on the training dataset to obtain a plurality of parameter value datasets respectively for the plurality of sample machine-learned models. For example, the different sample machine-learned models can be generated by randomly sampling hyperparameter values and/or initial parameter values. In another example, each sample model can be mutated from an existing sample model.

Each of the sample models can be trained on the training dataset (e.g., in a supervised training approach). For example, each sample model can be trained to predict the example output for each corresponding example input. Training can also be done via reinforcement learning or unsupervised learning. Each sample model can be trained to convergence or can be trained for a defined number of training iterations.

The parameter value dataset for each sample machine-learned model can include or describe parameter values obtained for parameters of the model after training of the model has been concluded. The parameter values can include weight values and/or hyperparameter values. The parameter value dataset can include the raw parameter values, flattened parameter values, one or more statistics derived from the parameter values, and/or one or more norms of the plurality of parameter values. Example statistics can include a mean, a variance, and/or one or more percentile values. The statistics and/or norms can be computed aggregately for all of the plurality of parameter values associated with the plurality of parameters of the assessed machine-learned model or can be computed independently for one or more of a plurality of layers of the assessed machine-learned model.

At 16, the computing system can determine a respective performance value of each of the plurality of sample machine-learned models. As examples, the performance value can include an accuracy value with respect to a separate testing dataset, an accuracy value with respect to some or all of the training dataset, an area under curve value, a compressibility value indicative of a level to which the model can be compressed, a robustness against adversarial attacks value, an out of distribution performance value, a mean squared error value, cross entropy loss value, and/or any other measures of performance of the model. The performance values can be computed for the models at one or more point(s) during training or can be computed at the conclusion of training.

In some implementations, the parameter value dataset can be captured at a first time (e.g., during training) and the performance values can be captured at a second, different time (e.g., after training has concluded). This can provide the ability to generate a dataset which can be used to train a predictor to predict future performance values for current incompletely trained models.

In some implementations, the parameter value dataset can be captured as a sequence of parameter values over time as the model is trained. A corresponding performance value can be evaluated at each point of capture or can be evaluated at the end of training. This can the ability to generate a dataset which can be used to train a dataset which can be used to train a predictor which is recurrent in nature (e.g., takes as input a sequence of parameter values over time steps of training and produces a predicted of the performance of the final trained model).

At 18, the computing system can label the parameter value dataset for each sample machine-learned model with its corresponding performance value to generate a sample model performance dataset.

At 20, the computing system can train a machine-learned performance prediction model using the sample model performance dataset. For example, supervised training techniques can be used to train the machine-learned performance prediction model based on the sample model performance dataset. As examples, the machine-learned performance prediction model can include various types of models such as a logit-linear model (L-Linear), gradient boosting machine using regression trees (GBM), a fully-connected DNN, and/or other forms of models.

### Example Sample Model Performance Dataset and Predictor Training Details

In one example implementation of the method 10 of FIG. 1, a new sample model performance dataset was generated which can be referred to as the Small CNN Zoo. It contains weights of a fixed CNN architecture trained on 4 different image datasets using a large number of different hyperparameter configurations. For each network, accuracy and cross-entropy loss on the train and test data are available.

The Small CNN Zoo Dataset

To enable predicting accuracy from the flattened weight vector, the number of weights in the architecture was kept small: 3 convolutional layers with 16 filters each, followed by global average pooling and a fully connected layer, for a total of 4 970 learnable weights. As a result, the best test accuracies obtained on CIFAR10 and SVHN were 55% and 75%, which is far below state of the art. However, it is worth pointing out that the smallest CNN architectures achieving above 90% test accuracy on CIFAR10 require on the order of 10\hat{ }6 parameters, i.e. 200× more.

These sample models were trained on 4 natural image classification problems: MNIST, Fashion MNIST, grayscale CIFAR10 (CIFAR10-GS), and grayscale SVHN (SVHN-GS). Global average pooling and using grayscale allows application of the same architecture across images of variable resolutions and number of channels. These vision tasks are examples. Non-vision tasks can be handled in the same manner.

For each dataset, 20 k different hyperparameter configurations were chosen independently at random from pre-specified ranges. Learning rate, type of initialization and its variance, fraction of the training examples to use, activation function, dropout rate, and L2-regularization of weights were all varied. One random seed per hyperparameter configuration was used to avoid leakage. One random seed was used per hyperparameter configuration to avoid having models that are too similar between the train and test splits of the CNN collections, which possibly leads to a leakage. Adam was used as the optimization algorithm.

Instead of stopping training when networks converge or reach a certain level of accuracy (which are options), each CNN was instead trained 18 epochs. This was done to facilitate the study of CNNs under general conditions: properties discovered by only looking at converged models may not hold for intermediate steps.

Finally, models in which numerical instabilities (e.g. infinite gradients) were detected were discarded. This process leads to 4 CNN collections: [symbol] _{M} with 16 183 CNNs for MNIST, [symbol] _{F} with 17 112 for Fashion MNIST, [symbol] _{C} with 19 995 for CIFAR10-GS, and [symbol] _{S} with 19 994 for SVHN-GS. The Small CNN Zoo is the union of these 4 collections. Overfitting was not observed in the Small CNN Zoo dataset: train and test accuracies are nearly identical for most CNNs, likely due to the small architecture used.

Example Training of the Estimators

Once the CNN collection [symbol] :={(Wₖ,Tₖ)}ₖ₌₁^{K} with weights Wₖ∈ [symbol] ^{4 970} and their test accuracies Tₖ was obtained, various estimators \hat{F}:W→[0,1] were trained. Below is a description of the training of several example estimators. These details are provided as examples only and other implementations details can be used instead to fulfill various objectives.

Three example types of estimators that were used include: a logit-linear model (L-Linear), gradient boosting machine using regression trees (GBM), and a fully-connected DNN. All three methods can be trained to minimize mean squared error over the sample dataset. Other model types can be used as well.

For the logit-linear model, weights and offsets were trained using mini-batch SGD/Adam varying the learning rate, batch size, initialization, and [symbol] ₂-regularization. LightGBM was used to train the GBM model and vary the number of leaves and maximum depth of the trees, the learning rate, [symbol] ₁ and [symbol] ₂ regularization, and parameters for the features/examples subsampling. A feed-forward fully-connected architecture was used for the DNN model with ReLU activations and sigmoid transform and it was trained with mini-batch SGD/Adam varying the learning rate, number of layers and their width, [symbol] ₂-regularization, initialization type and variance, and batch size.

Example input features which can be generated by preprocessing the weight vectors W before feeding them to the estimators include: (1) Using flattened parameters (weights/kernels and biases) of a single [symbol] -th layer [symbol] =1, . . . , 4 (W⁴ stands for the last fully connected layer); (2) Using statistics \tilde{W} of the entire flattened vector consisting of 7 real numbers: the mean, the variance, and q-th percentiles for q∈{0,25,50,75,100}; (3) Computing the above statistics for each layer [symbol] =1, . . . , 4 separately, while processing kernels and biases independently, and concatenating the results, which yields 4×2×7=56 real-valued features \tilde{W}_{L}; and/or (4) Computing [symbol] ₁ or [symbol] ₂ norms for each layer [symbol] =1, . . . , 4 separately, while processing kernels and biases independently, and then concatenating the results, which yields 4×2=8 real-valued features [symbol] and [symbol] .

An example training protocol and metrics are as follows: Each of the 4 CNN collections were divided into two splits: 15 k CNNs were used for the training split and the remaining ones were held out for the test split. In the example experiments, the entire training and hyperparameter selection for the models took place on the training splits. The test splits were used only once to evaluate the single best model that was chosen based on the 3-fold cross-validation.

Hyperparameter selection can be performed by evaluating 1 k unique configurations sampled randomly and independently from pre-specified ranges for every combination of estimator type, input features, and CNN collection. In all experiments mean squared error was used as the training objective. Other training objectives for the predictor model can be used as well.

### Example Use of the Trained Performance Prediction Model to Facilitate Early Stopping

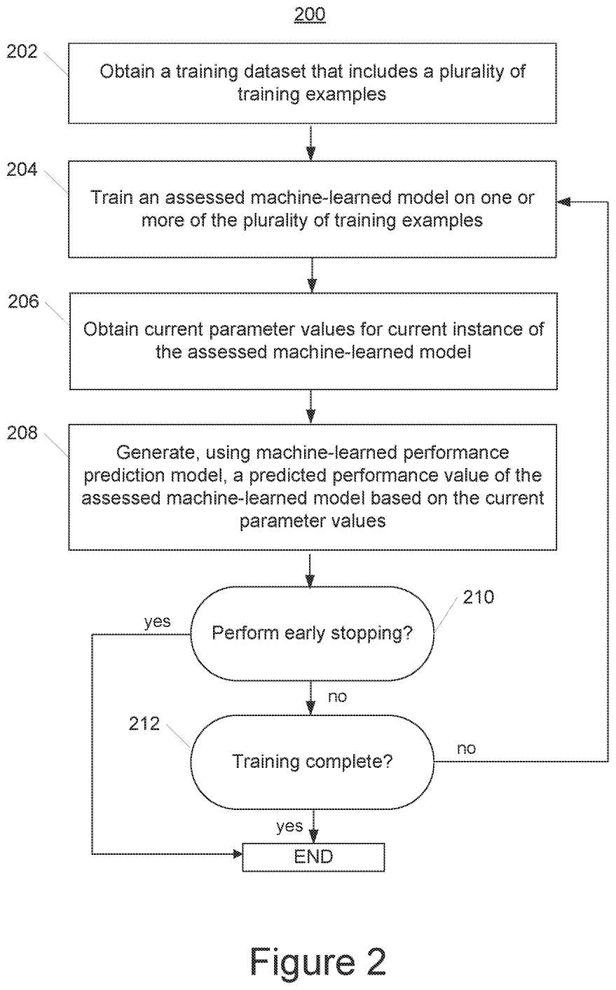

FIG. 2 depicts a flow chart diagram of an example method 200 to use a machine-learned performance prediction model according to example embodiments of the present disclosure. Although FIG. 2 depicts steps performed in a particular order for purposes of illustration and discussion, the methods of the present disclosure are not limited to the particularly illustrated order or arrangement. The various steps of the method 20 can be omitted, rearranged, combined, and/or adapted in various ways without deviating from the scope of the present disclosure.

At 202, a computing system can obtain a training dataset that includes a plurality of training examples. For example, the training dataset can have a number of example inputs that are labelled with corresponding example outputs. The inputs can be of any different data domain including imagery, text, audio, numerical data, other domains of data and/or combinations thereof. The outputs can be ground truth class labels, regression labels, or other forms of outputs.

At 204, the computing system can train an assessed machine-learned model on one or more of the plurality of training examples. For example, a minibatch of training examples can be used at 204. As another example, a batch of training examples can be used at 204. As another example, an epoch of training can be performed at 204.

At 206, the computing system can obtain current parameter values for the current instance of the assessed machine-learned model. These can be the current parameter values following the completion of training on the one or more training examples at 204.

At 208, the computing system can generate, using a machine-learned performance prediction model, a predicted performance value for the assessed machine-learned model based on the current parameter values obtained at 206. The machine-learned performance prediction model can have been trained as described in FIG. 1. The training dataset obtained at 202 can be the same as, different from, and/or related to the training dataset used to train the sample models on which the machine-learned performance prediction model is trained.

At 210, the computing system can determine whether to perform early stopping of training of the assessed machine-learned model based on the predicted performance value generated at 208.

In one example, determining whether to perform early stopping of the training of the assessed machine-learned model based at least in part on the predicted performance value of the assessed machine-learned model can include: comparing the predicted performance value of the assessed machine-learned model to a threshold performance value; and determining that early stopping should be performed when the predicted performance value of the assessed machine-learned model is less than the threshold performance value. Thus, early stopping can be performed if the predicted performance of the assessed model is less than some threshold.

In another example, determining whether to perform early stopping of the training of the assessed machine-learned model based at least in part on the predicted performance value of the assessed machine-learned model can include: comparing the predicted performance value of the assessed machine-learned model to an alternative performance value associated with an alternative machine-learned model; and determining that early stopping should be performed when the predicted performance value of the assessed machine-learned model is less than the alternative performance value associated with the alternative machine-learned model. For example, early stopping can be performed if the predicted performance of the assessed model is less than the performance value associated with some other model that is can be used as an alternative to the assessed model.

In some implementations, determining whether to perform early stopping of the training of the assessed machine-learned model based at least in part on the predicted performance value of the assessed machine-learned model can include determining whether a count of consecutive instances of the predicted performance value meeting some criteria (e.g., being less than a threshold value or alternative value) exceeds a threshold counter value. Thus, for example, if for 5 consecutive instances of step 210, the predicted performance value for the assessed model meets the criteria, then early stopping can be performed.

In yet another example, determining whether to perform early stopping of the training of the assessed machine-learned model based at least in part on the predicted performance value of the assessed machine-learned model can include: generating a performance versus training round plot based on the predicted performance value of the assessed machine-learned model; and determining whether to perform early stopping of the training of the assessed machine-learned model based at least in part on the performance versus training round plot. For example, if a final value of the performance versus training round plot meets a criteria (e.g., is less than a threshold value or alternative value), then early stopping can be performed. In such fashion, multiple predicted performance values generated over the course of training can be used to predict (e.g., via plotting) a final performance value that would result from completing training.

If it is determined at 210 that early stopping should be performed, then method 200 can end. However, if it is determined at 210 that early stopping should not be performed, then method 200 can proceed to 212.

At 212, the computing system can determine whether training is complete. For example, training can be determined to be complete when one or more stopping criteria are met. The stopping criteria can be any number of different criteria including as examples, a loop counter reaching a predefined maximum, iteration over iteration change in parameter adjustments falling below a threshold, the gradient being below a threshold value, and/or various other criteria.

After the stopping criteria is met, method 200 can provide an optimized version of the assessed machine-learned model as an output. The optimized version of the machine-learned model can include a final set of values for the plurality of parameters that were obtained at the final iteration of step 208.

However, if training has not yet completed, then method 200 can return to 204 and train the assessed model on or more of the plurality of training examples of the training dataset.

The method 200 of FIG. 2 can be performed independently for a single assessed model (e.g., at any instance of training a model).

Alternatively, the method 200 can be performed many assessed models in parallel. As one example, the method 200 can be used to cull a large corpus of assessed models into a smaller set. For example, method 200 can be performed in parallel for many different assessed models. At each instance of 210, training of some percentage of the assessed models that received the worst predicted performance values can be early stopped. Over time, a greatly reduced set of assessed models which have the best performance can be obtained and trained with reduced computational requirements.

Similarly, the early stopping framework applied in FIG. 2 can be incorporated into an iterative neural architecture search approach. For example, search candidates can be discarded from (or denied entry to) a corpus of potential architectures if their predicted performance values meet some criteria (e.g., is less than a threshold value or alternative value).

### Example Devices and Systems

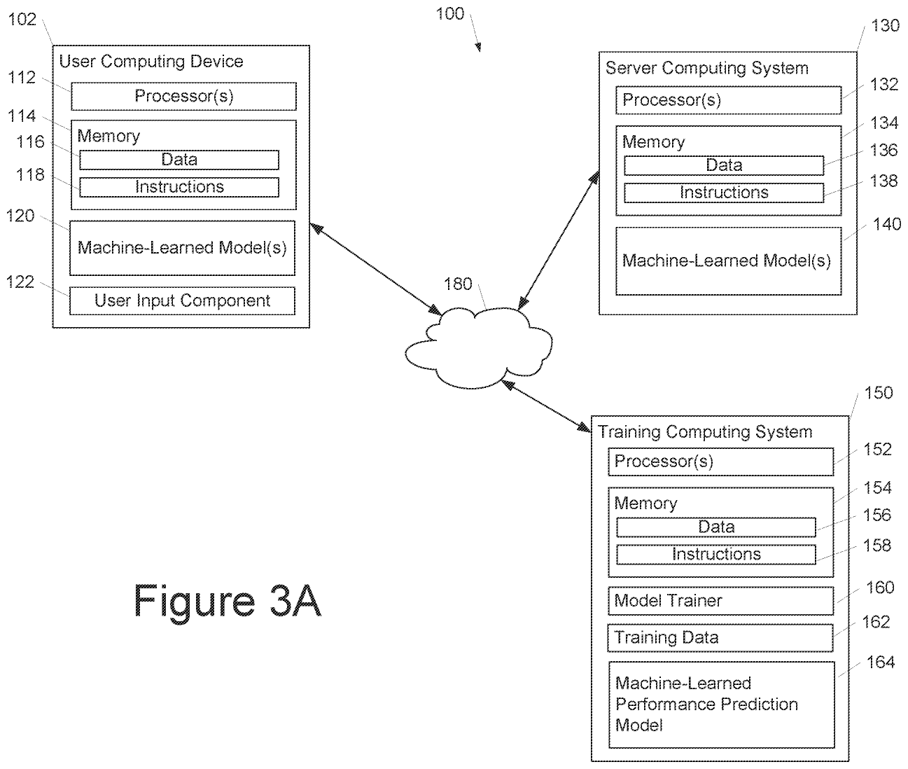

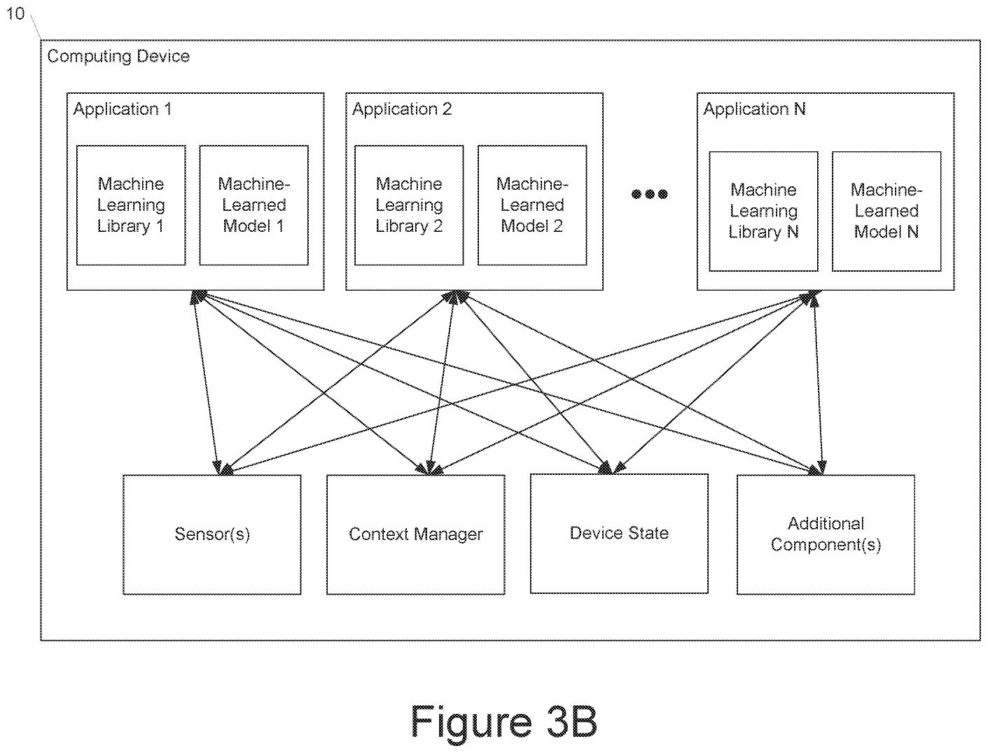

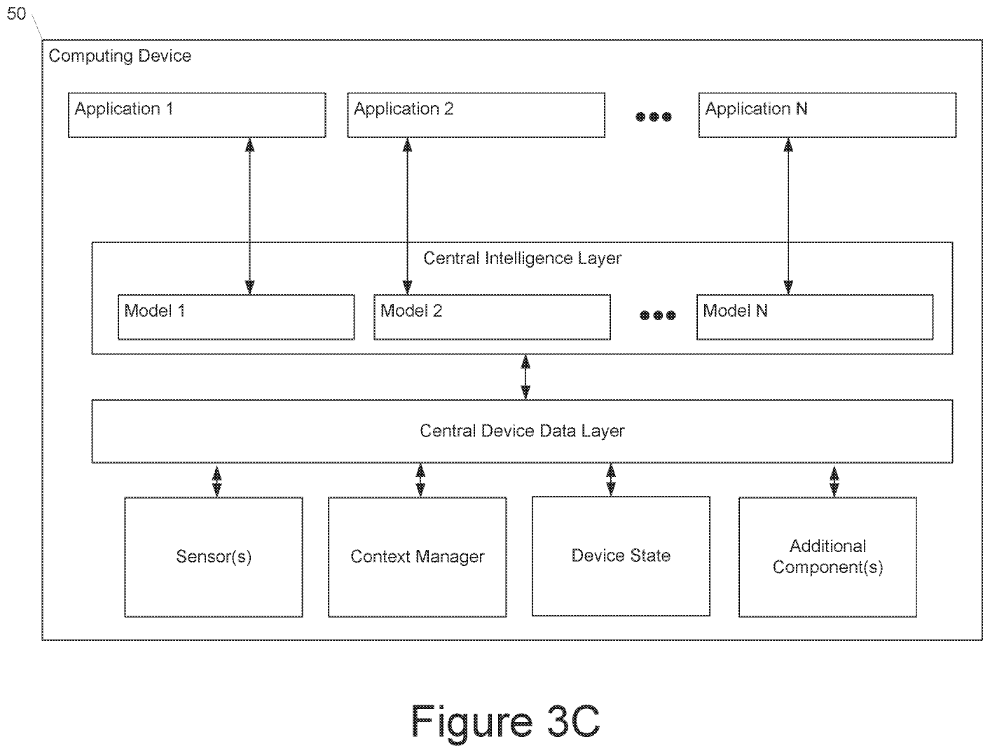

FIG. 3A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained. In particular, the model trainer 160 can train the machine-learned models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system to predict a performance value of a machine-learned model based on its parameter values, the computer system comprising:
one or more processors; and
one or more non-transitory computer-readable media that collectively store:
a machine-learned performance prediction model that has been trained to predict performance values of machine-learned models based on their parameter values; and
instructions that, when executed by the one or more processors, cause the computing system to perform operations, the operations comprising:
obtaining data descriptive of a plurality of parameter values associated with a plurality of parameters of an assessed machine-learned model;
inputting the data descriptive of the plurality of parameter values associated with the plurality of parameters of the assessed machine-learned model into the machine-learned performance prediction model;
generating, using the machine-learned performance prediction model, a predicted performance value of the assessed machine-learned model based on the data descriptive of the plurality of parameter values associated with the plurality of parameters of the assessed machine-learned model; and
providing the predicted performance value of the assessed machine-learned model as an output.

2. The computing system of claim 1, wherein:
said operations of obtaining, inputting, generating, and providing are performed during training of the assessed machine-learned model; and
the operations further comprise determining, by the computing system, whether to perform early stopping of the training of the assessed machine-learned model based at least in part on the predicted performance value of the assessed machine-learned model.

3. The computing system of claim 1, wherein:
the assessed machine-learned model comprises a neural network; and
the plurality of parameter values comprise a plurality of weight values respectively associated with the neural network.

4. The computing system of claim 1, wherein the plurality of parameter values associated with the plurality of parameters of the assessed machine-learned model comprise a plurality of hyperparameter values associated with the plurality of hyperparameters of the assessed machine-learned model.

5. The computing system of claim 1, wherein the performance value comprises a test accuracy value relative to a defined testing dataset.

6. The computing system of claim 5, wherein the test accuracy value comprises a future test accuracy value that assumes training of the assessed machine-learned model is completed to convergence.

7. The computing system of claim 1, wherein the data descriptive of the plurality of parameter values associated with the plurality of parameters of the assessed machine-learned model comprises:
a set of flattened parameter values of a single layer of the assessed machine-learned model.

8. The computing system of claim 1, wherein the data descriptive of the plurality of parameter values associated with the plurality of parameters of the assessed machine-learned model comprises:
one or more statistics descriptive of the plurality of parameter values associated with the plurality of parameters of the assessed machine-learned model.

9. The computing system of claim 8, wherein the one or more statistics comprise one or more of: a mean, a variance, and/or one or more percentile values for all of the plurality of parameter values associated with the plurality of parameters of the assessed machine-learned model.

10. The computing system of claim 8, wherein the one or more statistics comprise one or more of: a mean, a variance, and/or one or more percentile values of the plurality of parameter values associated with the plurality of parameters, computed independently for one or more of a plurality of layers of the assessed machine-learned model.

11. The computing system of claim 1, wherein the data descriptive of the plurality of parameter values associated with the plurality of parameters of the assessed machine-learned model comprises:
one or more norms of the plurality of parameter values associated with the plurality of parameters, computed independently for one or more of a plurality of layers of the assessed machine-learned model.

12. The computing system of claim 1, wherein the machine-learned performance prediction model comprises a gradient boosting machine with regression trees.

13. The computing system of claim 1, wherein the machine-learned performance prediction model comprises a logit-linear model or a fully-connected neural network.

14. A computer-implemented method for performing early stopping of machine-learned model training, the method comprising:
obtaining, by a computing system comprising one or more computing devices, a training dataset and an assessed machine-learned model to be trained on the training dataset;
training, by the computing system, the assessed machine-learned model on the training dataset for a plurality of training iterations, wherein one or more of the plurality of training iterations comprises:
obtaining, by the computing system, data descriptive of a plurality of current parameter values associated with a plurality of parameters of a current instance of the assessed machine-learned model;
inputting, by the computing system, the data descriptive of the plurality of current parameter values into a machine-learned performance prediction model;
generating, by the computing system and using the machine-learned performance prediction model, a predicted performance value of the assessed machine-learned model based on the data descriptive of the plurality of current parameter values; and
determining, by the computing system, whether to perform early stopping of the training of the assessed machine-learned model based at least in part on the predicted performance value of the assessed machine-learned model.

15. The computer-implemented method of claim 14, further comprising, at at least one training iteration of the plurality of training iterations:
performing early stopping of the training of the assessed machine-learned model based at least in part on the predicted performance value of the assessed machine-learned model.

16. The computer-implemented method of claim 14, wherein determining whether to perform early stopping of the training of the assessed machine-learned model based at least in part on the predicted performance value of the assessed machine-learned model comprises:
comparing the predicted performance value of the assessed machine-learned model to a threshold performance value; and
determining that early stopping should be performed when the predicted performance value of the assessed machine-learned model is less than the threshold performance value.

17. The computer-implemented method of claim 14, wherein determining whether to perform early stopping of the training of the assessed machine-learned model based at least in part on the predicted performance value of the assessed machine-learned model comprises:
comparing the predicted performance value of the assessed machine-learned model to an alternative performance value associated with an alternative machine-learned model; and
determining that early stopping should be performed when the predicted performance value of the assessed machine-learned model is less than the alternative performance value associated with the alternative machine-learned model.

18. The computer-implemented method of claim 14, wherein determining whether to perform early stopping of the training of the assessed machine-learned model based at least in part on the predicted performance value of the assessed machine-learned model comprises:
generating a performance versus training round plot based on the predicted performance value of the assessed machine-learned model; and
determining whether to perform early stopping of the training of the assessed machine-learned model based at least in part on the performance versus training round plot.

19. The computer-implemented method of claim 14, wherein:
the machine-learned performance prediction model comprises a recurrent neural network; and
inputting, by the computing system, the data descriptive of the plurality of current parameter values into the machine-learned performance prediction model comprises inputting to machine-learned performance prediction model a sequence of sets of parameter values of sequential instances of the assessed machine-learned model obtained at a number of training checkpoints.

20. One or more non-transitory computer-readable media that collectively store instructions that, when executed by one or more processors, cause the one or more processors to perform operations, the operations comprising:
generating a sample model performance dataset by labelling a plurality of parameter value datasets respectively associated with a plurality of sample machine-learned models with a corresponding performance value exhibited by the corresponding sample machine-learned model; and
using the sample model performance dataset to train a machine-learned performance prediction model to predict the performance values of the sample machine-learned models based on the corresponding parameter value dataset.
